(19) United States
(12) Patent Application Publication
(10) Pub. No.: US 2007/0253129 A1
(43) Pub. Date: Nov. 1, 2007

(54) Coil Load Drive Circuit and Optical Disk Device Having the Same

(75) Inventor: Hiroshi Yoshikawa, Kyoto-shi (JP)

Correspondence Address: FISH & RICHARDSON P.C., P.O. BOX 1022, MINNEAPOLIS, MN, 55440-1022, US

(73) Assignee: ROHM CO., LTD., Kyoto (JP)

(21) Appl. No.: 11/659,778

(22) PCT Filed: Aug. 29, 2005
(86) PCT No.: PCT/JP05/15616

§ 371 Date: Feb. 7, 2007

(30) Foreign Application Priority Data
Sep. 13, 2004 (JP) 2004-265062

(51) Int. Cl. H02H 3/08

(52) U.S. Cl. 361/93.1

(57) ABSTRACT

A coil load drive circuit drives an end of a coil load through an output terminal at the midpoint between a power supply side drive transistor and a ground side drive transistor provided in series between a power supply voltage and a ground potential, and turns off any of the drive transistors when an overcurrent flows therethrough. The coil load drive circuit includes an overcurrent detection transistor receiving a control voltage of the power supply side drive transistor or a control voltage of the ground side drive transistor, a constant current source supplying a constant current to the overcurrent detection transistor to generate a reference voltage, and an overcurrent detection comparator comparing a voltage of the output terminal with the reference voltage to detect an overcurrent.

### TECHNICAL FIELD

The present invention relates to a coil load drive circuit having an overcurrent protective circuit, and an optical disk device provided with the coil load drive circuit.

### BACKGROUND ART

FIG. 8 shows a conventional coil load drive circuit 100 having drive transistors Qₕₚ₁, Qₗₙ₁, Qₕₚ₂ and Qₗₙ₂ which are connected in the shape of an H bridge so as to drive a coil load L, and also having an overcurrent protective circuit. In the figure, when the control signals from predrivers P1 and P2 are shifted from each other due to delay and the like, causing a through current in power supply side and ground side drive transistors Qₕₚ₁ and Qₗₙ₁, or Qₕₚ₂ and Qₗₙ₂, a large current (hereinafter referred to as an “overcurrent”) flows through these drive transistors Qₕₚ₁, Qₗₙ₁, Qₕₚ₂ and Qₗₙ₂. In the case of a short between output terminals T101 and T102 due to foreign substances and the like, and also in the case of an overload state and the like, an overcurrent flows through drive transistors Qₕₚ₁, Qₗₙ₁, Qₕₚ₂ and Qₗₙ₂. Since this overcurrent may destroy drive transistors Qₕₚ₁, Qₗₙ₁, Qₕₚ₂ and Qₗₙ₂, an overcurrent detection resistance R& and an overcurrent detection comparator CMP1 for detecting the current flowing through power supply side drive transistors Qₕₚ₁ and Qₕₚ₂ are provided as an overcurrent protective circuit for preventing an overcurrent.

For example, in the case where drive transistors Qₕₚ₁, and Qₗₙ₂ are on and drive transistors Qₕₚ₂ and Qₗₙ₁ are off, and an overcurrent flows in the direction of the arrow shown in the figure, the voltage which drops due to overcurrent detection resistance R_{d} will increase. Therefore, the voltage input to an inverting input terminal of overcurrent detection comparator CMP1 becomes lower than a reference voltage V_{ref} input to a non-inverting input terminal thereof. Overcurrent detection comparator CMP1 detects this, and transmits a signal to predrivers P1 and P2 to turn off drive transistors Qₕₚ₁, Qₗₙ₁, Qₕₚ₂ and Qₗₙ₂.

Such a technique is described in the following Japanese Patent Laying-Open No. 5-236797 (Patent Document 1).

Patent Document 1: Japanese Patent Laying-Open No. 5-236797

### DISCLOSURE OF THE INVENTION

### Problems to be Solved by the Invention

In coil load drive circuit 100 described above, however, the current flowing through drive transistors Qₕₚ₁, Qₗₙ₁, Qₕₚ₂ and Qₗₙ₂ and coil load L is relatively high even under normal operating conditions. This usually requires overcurrent detection resistance R_{d} to be lower than 1Ω and to have high precision in order to ensure the dynamic range of the output voltage. Therefore, an external resistance of highly precision is often used as overcurrent detection resistance R_{d}, which leads to an increase in cost. Furthermore, in the electric equipment such as an optical disk device using such coil load drive circuit, the printed board on which overcurrent detection resistance R_{d} is mounted may increase in size.

The present invention has been made in light of the above-described reasons. An object of the present invention is to provide a coil load drive circuit which requires no external resistance as an overcurrent detection resistance.

### MEANS FOR SOLVING THE PROBLEMS

In order to achieve the above-described object, a coil load drive circuit according to the present invention drives an end of a coil load through an output terminal at the midpoint between a power supply side drive transistor and a ground side drive transistor provided in series between a power supply voltage and a ground potential, and turns off any of the drive transistors when an overcurrent flows therethrough. The coil load drive circuit is characterized in that it includes an overcurrent detection transistor receiving a control voltage of the power supply side drive transistor or a control voltage of the ground side drive transistor, a constant current source supplying a constant current to the overcurrent detection transistor to generate a reference voltage, and an overcurrent detection comparator comparing a voltage of the output terminal with the reference voltage to detect an overcurrent.

Another coil load drive circuit according to the present invention drives both ends of a coil load through a first output terminal at the midpoint between a first power supply side drive transistor and a first ground side drive transistor provided in series between a power supply voltage and a ground potential, and a second output terminal at the midpoint between a second power supply side drive transistor and a second ground side drive transistor provided in series between the power supply voltage and the ground potential, and turns off any of the drive transistors when an overcurrent flows therethrough. The coil load drive circuit is characterized in that it includes a first overcurrent detection transistor receiving a control voltage of the first power supply side drive transistor or a control voltage of the first ground side drive transistor, a second overcurrent detection transistor receiving a control voltage of the second power supply side drive transistor or a control voltage of the second ground side drive transistor, a constant current source selectively supplying a constant current to the first or second overcurrent detection transistor to generate a reference voltage, and an overcurrent detection comparator selectively comparing a voltage of the first or second output terminal with the reference voltage to detect an overcurrent.

Yet another coil load drive circuit according to the present invention drives a 3-phase coil load through a first output terminal at the midpoint between a first power supply side drive transistor and a first ground side drive transistor provided in series between a power supply voltage and a ground potential, a second output terminal at the midpoint between a second power supply side drive transistor and a second ground side drive transistor provided in series between the power supply voltage and the ground potential, and a third output terminal at the midpoint between a third power supply side drive transistor and a third ground side drive transistor provided in series between the power supply voltage and the ground potential, and turns off any of the drive transistors when an overcurrent flows therethrough. The coil load drive circuit is characterized in that it includes a first overcurrent detection transistor receiving a control voltage of the first power supply side drive transistor or a control voltage of the first ground side drive transistor, a second overcurrent detection transistor receiving a control voltage of the second power supply side drive transistor or a control voltage of the second ground side drive transistor, a third overcurrent detection transistor receiving a control voltage of the third power supply side drive transistor or a control voltage of the third ground side drive transistor, a constant current source selectively supplying a constant current to the first, second or third overcurrent detection transistor to generate a reference voltage, and an overcurrent detection comparator selectively comparing a voltage of the first, second or third output terminal with the reference voltage to detect an overcurrent.

Preferably, the coil load drive circuit is characterized in that it includes means for controlling input timing of the voltage compared by the overcurrent detection comparator.

In particular, the coil load drive circuit is characterized in that the means for controlling the input timing of the voltage compared by the overcurrent detection comparator is a timing control circuit which controls the timings of the control voltage of the power supply side drive transistor or the control voltage of the ground side drive transistor and the control voltage of the overcurrent detection transistor.

An optical disk device according to the present invention is characterized in that it includes the above-described coil load drive circuit.

### EFFECTS OF THE INVENTION

In the coil load drive circuit according to the present invention, the overcurrent detection transistor is provided to generate a reference voltage, with which the voltage of the output terminal is compared, to detect an overcurrent. Thus, no external resistance is required as an overcurrent detection resistance, so that cost reduction can be achieved. In addition, temperature has no effect on a current value by which it is determined that an overcurrent occurs, which allows accurate overcurrent detection to be performed. Furthermore, the optical disk device according to the present invention provided with the coil load drive circuit can achieve reduction in cost and size.

### BRIEF DESCRIPTION OF THE DRAWINGS

FIG. 1 is a circuit diagram of a first embodiment of a coil load drive circuit according to the present invention.

FIG. 2 is a circuit diagram of a second embodiment of the coil load drive circuit according to the present invention.

FIG. 3 is a circuit diagram of a third embodiment of the coil load drive circuit according to the present invention.

FIG. 4 is a circuit diagram of a fourth embodiment of the coil load drive circuit according to the present invention.

FIG. 5 is a circuit diagram of a fifth embodiment of the coil load drive circuit according to the present invention.

FIG. 6 is a circuit diagram of a sixth embodiment of the coil load drive circuit according to the present invention.

FIG. 7 is a configuration diagram of an optical disk device.

FIG. 8 is a circuit diagram of a conventional coil load drive circuit.

### DESCRIPTION OF THE REFERENCE SIGNS

1-7 coil load drive circuit, L, U_{L}, V_{L}, W_{L} coil load, T1, T2, T_{U}, T_{V}, T_{W} output terminal, Qₕₚ₁, Qₕₚ₂, Q_{UHP}, Q_{VHP}, Q_{WHP} power supply side drive transistor, Qₗₙ₁, Qₗₙ₂, Q_{UL}, Q_{VL}, Q_{WL} ground side drive transistor, Q_{dp1}, Q_{dp2}, Q_{dup}, Q_{dvp}, Q_{dwp}, Q_{dun}, Q_{dvn}, Q_{dwn} overcurrent detection transistor, I₀₁, I₀₂, I₁ₗ constant current source, CMP1, CMP2 overcurrent detection comparator, L1, L2 timing control circuit.

### BEST MODES FOR CARRYING OUT THE INVENTION

The embodiments of the present invention will be described in detail with reference to the drawings, in which the same or corresponding components are designated by the same reference characters, and description thereof will not be repeated.

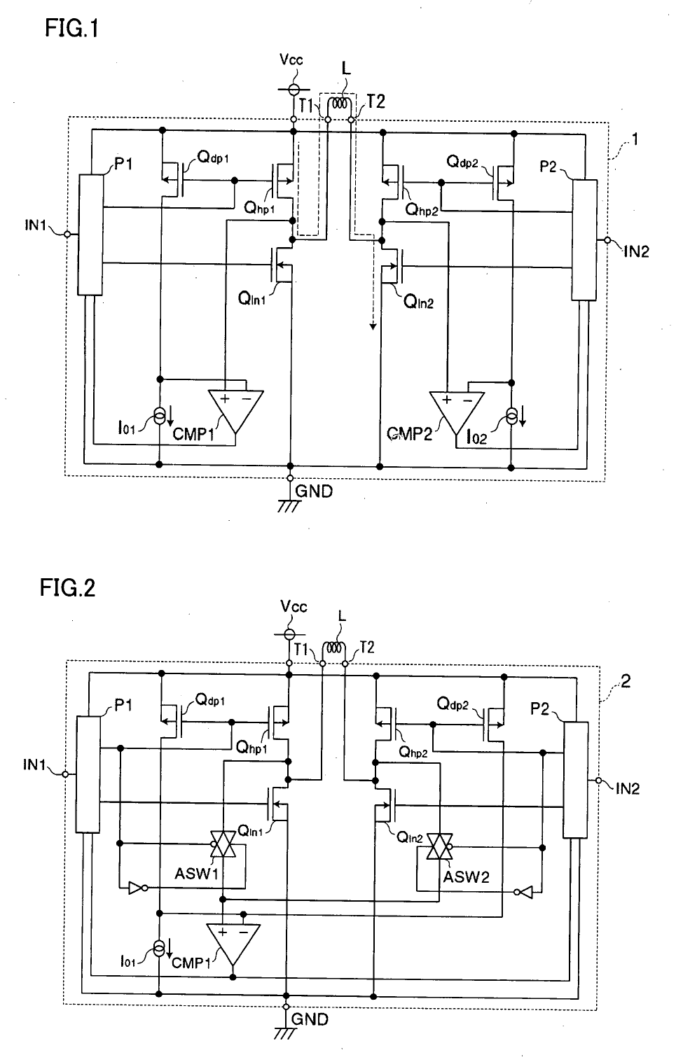

The best mode for carrying out the present invention will be hereinafter described. FIG. 1 shows a first embodiment of a coil load drive circuit according to the present invention. The coil load drive circuit 1 (and coil load drive circuits 2 to 5 described below) is, for example, applied to a coil load drive circuit which drives a coil load of an optical pickup and a thread motor configuring an optical disk device. Drive transistors Qₕₚ₁, Qₗₙ₁, Qₕₚ₂ and Qₗₙ₂ of coil load drive circuit 1 (and coil load drive circuits 2 to 5 described below) are connected in the shape of an H-bridge via a coil load L.

The first power supply side drive transistor Qₕₚ₁ which is a P-MOS transistor and the first ground side drive transistor Qₗₙ₁ which is an N-MOS transistor are connected in series between a power supply voltage Vcc and a ground potential, and drive an end of coil load L through a first output terminal T1 at the midpoint therebetween. A predriver P1 outputs a voltage of high level or low level, based on a comparison result between a control signal input via an input terminal IN1 from the outside and a first overcurrent detection comparator CMP1 described below, to control on and off of first power supply side drive transistor Qₕₚ₁ and first ground side drive transistor Qₗₙ₁.

A first overcurrent detection transistor Q_{dp1}, which is a P-MOS transistor, has a smaller area than that of first power supply side drive transistor Qₕₚ₁(for example, one hundredth of the area), and has a gate in common therewith, through which it receives a control voltage. First overcurrent detection transistor Q_{dp1} can achieve the object described below, even with a size of about one twentieth to one two-thousandth, relative to first power supply side drive transistor Qₕₚ₁.

Furthermore, it is desirable that first overcurrent detection transistor Q_{dp1} has the same shape as first power supply side drive transistor Qₕₚ₁ with a common gate length, to improve matching. A drain of first overcurrent detection transistor Q_{dp1} is provided with a first constant current source I₀₁, which supplies a constant current thereto, to generate a reference voltage.

First overcurrent detection comparator CMP1 has a non-inverting input terminal to which a voltage of the drain of first power supply side drive transistor Qₕₚ₁, i.e., that of a first output terminal T1, is input, and an inverting input terminal to which a voltage of the drain of first overcurrent detection transistor Q_{dp1} is input as a reference voltage, and outputs a comparison result therebetween to predriver P1. If the comparison result indicates an overcurrent, predriver P1 outputs a voltage of high level or low level which turns off first power supply side drive transistor Qₕₚ₁ and first ground side drive transistor Qₗₙ₁.

An input terminal IN2, a predriver P2, the second power supply side drive transistor Qₕₚ₂, the second ground side drive transistor Qₗₙ₂, a second output terminal T2, a second overcurrent detection transistor Q_{dp2}, a second overcurrent detection comparator CMP2 and a second constant current source 102 correspond to and are connected in the same manner as input terminal IN1, predriver P1, first power supply side drive transistor Qₕₚ₁, first ground side drive transistor Qₗₙ₁, first output terminal T1, first overcurrent detection transistor Q_{dp1}, first overcurrent detection comparator CMP1 and first constant current source I₀₁, respectively, and therefore, detailed description thereof will not be repeated.

The operation of coil load drive circuit 1 will now be described. When the voltage to the gates of first power supply side drive transistor Qₕₚ₁ and first ground side drive transistor Qₗₙ₁ is at a low level, and the voltage to the gates of second power supply side drive transistor Qₕₚ₂ and second ground side drive transistor Qₗₙ₂ is at a high level, that is, when first power supply side drive transistor Qₕₚ₁ and second ground side drive transistor Qₗₙ₂ are on and first ground side drive transistor Qₗₙ₁ and second power supply side drive transistor Qₕₚ₂ are off, a current flows from first power supply side drive transistor Qₕₚ₁ to second ground side drive transistor Qₗₙ₂ (in the direction of the arrow shown by a long dashed line in the figure).

As a result, the voltage of the drain of first power supply side drive transistor Qₕₚ₁ corresponds to the level lower than a power supply voltage Vcc by the product of its on-resistance and the current flowing therethrough, and is input to the non-inverting input terminal of first overcurrent detection comparator CMP1. On the other hand, the voltage of the drain of first overcurrent detection transistor Q_{dp1}, that is, a reference voltage, corresponds to the level lower than power supply voltage Vcc by the product of its on-resistance and a constant current of first constant current source I₀₁, and is input to the inverting input terminal of first overcurrent detection comparator CMP1.

If an overcurrent flows through first power supply side drive transistor Qₕₚ₁, the voltage drop due to the on-resistance increases, and magnitudes of the voltages at the non-inverting input terminal and the inverting input terminal of first overcurrent detection comparator CMP1 are inverted, to also cause the output of first overcurrent detection comparator CMP1 to be inverted.

For example, assuming that the on-resistance of first overcurrent detection transistor Q_{dp1} is R_{ON} and the current value of first constant current source I₀₁ is I_{01A}, a voltage of (Vcc−(I_{01A}×R_{ON})) is input to the inverting input terminal of first overcurrent detection comparator CMP1. Assuming that the area of first power supply side drive transistor Qₕₚ₁ is N times larger than that of first overcurrent detection transistor Q_{dp1}, the on-resistance of first power supply side drive transistor Qₕₚ₁ is R_{ON}/N. Thus, assuming that the current amount flowing through coil L is I, a voltage of (Vcc−(I×R_{ON}/N)) is input to the non-inverting input terminal.

Therefore, if current value I_{01A} of first constant current source I₀₁ is set at 1/N of the current value by which it is determined that an overcurrent occurs, when current amount I flowing through coil L exceeds the same, the output of first overcurrent detection comparator CMP1 is inverted. Furthermore, also in the case where the current flows through coil L in the opposite direction, and an overcurrent flows through second power supply side drive transistor Qₕₚ₂ and first ground side drive transistor Qₗₙ₁, the output of second overcurrent detection comparator CMP2 is inverted. It is to be noted that the current value by which it is determined that an overcurrent occurs is decided based on the allowable current of drive transistors Qₕₚ₁, Qₕₚ₂, Qₗₙ₁ and Qₗₙ₂.

The outputs of first and second overcurrent detection comparators CMP1 and CMP2 are transmitted to predrivers P1 and P2, to control such that power supply side drive transistors Qₕₚ₁ and Qₕₚ₂ or ground side drive transistors Qₗₙ₁ and Qₗₙ₂ are turned off. In this way, the overcurrent is prevented from continuously flowing.

Therefore, according to the present embodiment, overcurrent detection transistors are provided to each generate a reference voltage, with which the voltages of output terminals T1 and T2 are compared, to detect an overcurrent. Thus, no external resistance as an overcurrent detection resistance is required, and cost reduction can be achieved.

Furthermore, the temperature characteristics of the on-resistances (R_{ON}/N) of power supply side drive transistors Qₕₚ₁ and Qₕₚ₂ and the temperature characteristics of the on-resistances (R_{ON}) of overcurrent detection transistors Q_{dp1} and Q_{dp2} are balanced out, and the current (of N times) proportional to current values I_{01A} and I_{02A} of first and second constant current sources I₀₁ and I₀₂ is determined to be an overcurrent irrespective of the temperature, and therefore, overcurrent detection can be accurately performed. In the above-described conventional coil load drive circuit, since the temperature characteristics of overcurrent detection resistance R_{d} which is an external resistance are not balanced out by a reference voltage V_{ref}, overcurrent detection is susceptible to temperature changes.

FIG. 2 shows a second embodiment of the coil load drive circuit according to the present invention. In the coil load drive circuit 2, first and second power supply side drive transistors Qₕₚ₁ and Qₕₚ₂, first and second ground side drive transistors Qₗₙ₁ and Qₗₙ₂, first and second output terminals T1 and T2, coil load L, predrivers P1 and P2, first and second overcurrent detection transistors Q_{dp1} and Q_{dp2} are connected in the same manner as in coil load drive circuit 1. Constant current source I₀₁ is provided which selectively supplies a constant current to first or second overcurrent detection transistor Q_{dp1} or Q_{dp2} to generate a reference voltage.

The current of constant current source I₀₁ is caused to selectively flow through first overcurrent detection transistor Q_{dp1} or second overcurrent detection transistor Q_{dp2}, in association with on and off of first and second power supply side drive transistors Qₕₚ₁ and Qₕₚ₂. Overcurrent detection comparator CMP1 has the non-inverting input terminal to which the voltage of the drain of first power supply side drive transistor Qₕₚ₁ (voltage of first output terminal T1) or the voltage of the drain of second power supply side drive transistor Qₕₚ₂ (voltage of second output terminal T2) is selectively input via analog switches ASW1 and ASW2, and also has the inverting input terminal to which the voltage of the drain of first overcurrent detection transistor Q_{dp1} or the voltage of the drain of second overcurrent detection transistor Q_{dp2} is selectively input as a reference voltage, and compares them to detect an overcurrent. The output of overcurrent detection comparator CMP1 is transmitted to predrivers P1 and P2, to control such that power supply side drive transistors Qₕₚ₁ and Qₕₚ₂ or ground side drive transistors Qₗₙ₁ and Qₗₙ₂ are turned off.

Since analog switch ASW1 is turned on in association with first power supply side drive transistor Qₕₚ₁ being on, for example, when the control voltage of first power supply side drive transistor Qₕₚ₁ is at a low level, analog switch ASW1 becomes conductive. Similarly, analog switch ASW2 is turned on in association with second power supply side drive transistor Qₕₚ₂ turning on. Therefore, when the control voltages of first power supply side drive transistor Qₕₚ₁ and first ground side drive transistor Qₗₙ₁ are at a low level and the control voltages of second power supply side drive transistor Qₕₚ₂ and second ground side drive transistor Qₗₙ₂ are at a high level, analog switch ASW1 is on, and the voltage of the drain of first power supply side drive transistor Qₕₚ₁ is input to the non-inverting input terminal of overcurrent detection comparator CMP1, while the voltage of the drain of first overcurrent detection transistor Q_{dp1} is input to the inverting input terminal thereof.

As with coil load drive circuit 1, coil load drive circuit 2 eliminates the need for an external resistance as an overcurrent detection resistance, to thereby achieve cost reduction and to allow accurate overcurrent detection to be performed irrespective of the temperature. In addition, since only one comparator occupying a large area as compared with coil load drive circuit 1 is required, the circuit scale can be reduced accordingly. It is to be noted that two additional analog switches have little effect. Also, only one constant current source is required, which results in lower standby current and less power consumption.

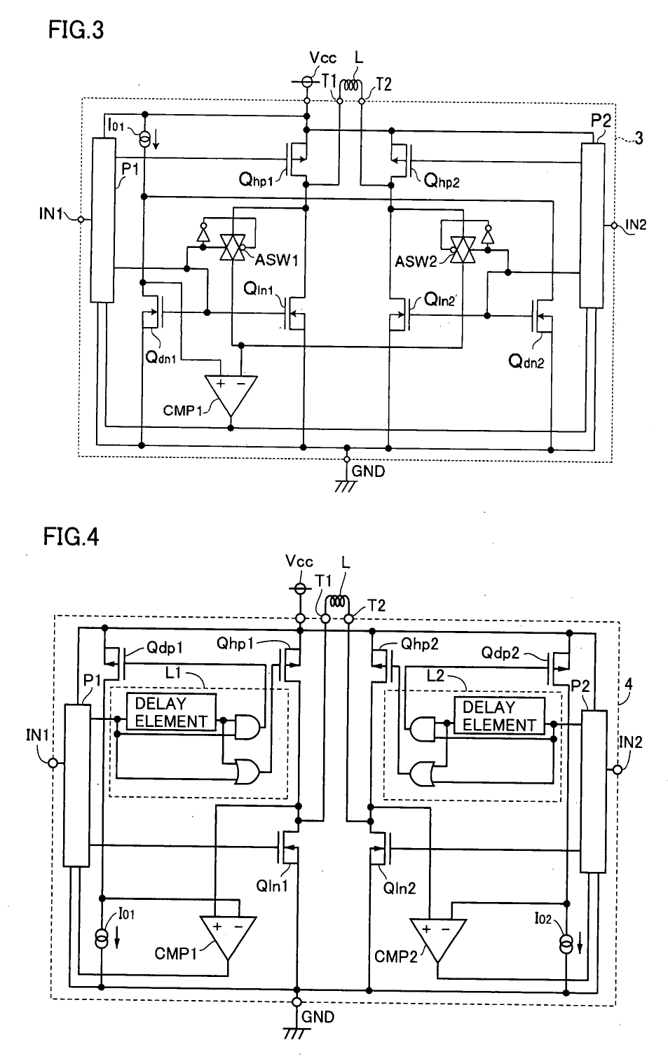

A third embodiment of the coil load drive circuit according to the present invention will now be described with reference to FIG. 3. The coil load drive circuit 3 is provided with a first overcurrent detection transistor Q_{dn1} and a second overcurrent detection transistor Q_{dn2}, which are N-MOS transistors, arranged in parallel with first ground side drive transistor Qₗₙ₁ and second ground side drive transistor Qₗₙ₂. Constant current source 10, selectively supplies a current from the power supply side to first overcurrent detection transistor Q_{dn1} or second overcurrent detection transistor Q_{dn1}. The reference voltage generated in overcurrent detection transistor Q_{dn1} or Q_{dn2} is then input to the non-inverting input terminal of overcurrent detection comparator CMP1. The voltage of the drain of first ground side transistor Qₗₙ₁ or second ground side transistor Qₗₙ₂ (voltage of first output terminal T1 or second output terminal T2) is selectively input to the inverting input terminal of overcurrent detection comparator CMP1.

If a current increases at first ground side transistor Qₗₙ₁ or second ground side transistor Qₗₙ₂ the voltage caused by its on-resistance will increase. In overcurrent detection comparator CMP1, the voltage of the inverting input terminal becomes greater than the reference voltage input to the non-inverting input terminal when an overcurrent flows, and therefore, it inverts the output and provides the inverted output to predrivers P1 and P2.

In the above-described coil load drive circuits 1-3, the first and second power supply side drive transistors are P-MOS transistors. However, it is also possible to replace these P-MOS transistors with N-MOS transistors which occupy a smaller area in terms of the same current drive capability, to thereby reduce the circuit scale.

FIG. 4 shows a fourth embodiment of the present invention. As compared with the above-described coil load drive circuit 1, the coil load drive circuit 4 differs in that the gates of overcurrent detection transistors Q_{dp1} and Q_{dp2} are not directly connected to respective gates of power supply side drive transistors Qₕₚ₁ and Qₕₚ₂, and timing control circuits L1 and L2 for timing control are inserted therebetween. That is, timing control circuits L1 and L2 function to control the timings such that the on-times of overcurrent detection transistors Q_{dp1} and Q_{dp2} completely include the on-times of power supply side drive transistors Qₕₚ₁ and Qₕₚ₂, and consequently, function to control the input timings of the voltages compared by overcurrent detection comparators CMP1 and CMP2.

This is performed to prevent that power supply side drive transistors Qₕₚ₁ and Qₕₚ₂, and overcurrent detection transistors Q_{dp1} and Q_{dp2} simultaneously perform a transient operation, the drain voltage of power supply side drive transistors Qₕₚ₁ and Qₕₚ₂ momentarily drop lower than the reference voltage due to noise and the like, the outputs of overcurrent detection comparators CMP1 and CMP2 are inverted, and predrivers P1 and P2 momentarily malfunction. Specifically, timing control circuits L1 and L2 can each be implemented with a delay element (DELAY) which delays the rise and fall of the output voltage of predriver P1, P2, an AND circuit and an OR circuit, as shown in FIG. 4.

Although coil load drive circuit 4 is improved by modifying coil load drive circuit 1, coil load drive circuits 2 and 3 can also be modified in a similar manner.

Described below is the present invention which is applied, for example, to a coil load drive circuit that drives a 3-phase coil load of a spindle motor configuring an optical disk. Coil load drive circuits 5 and 6 which are modified from coil load drive circuits 2 and 3, respectively, will be hereinafter described.

In coil load drive circuit 5 which is a fifth embodiment of the present invention shown in FIG. 5, a first power supply side drive transistor Q_{UHP} and a first ground side drive transistor Q_{UL} are connected in series between power supply voltage Vcc and the ground potential, a first output terminal T_{U} at the midpoint therebetween is connected to a U-phase coil load U_{L}, a second power supply side drive transistor Q_{VHP} and a second ground side drive transistor Q_{VL} are connected in series between power supply voltage Vcc and the ground potential, a second output terminal T_{V} at the midpoint therebetween is connected to a V-phase coil load V_{L}, a third power supply side drive transistor Q_{WHP} and a third ground side drive transistor Q_{WL} are connected in series between power supply voltage Vcc and the ground potential, and a third output terminal T_{W} at the midpoint therebetween is connected to a W-phase coil load W_{L}.

Power supply side drive transistors Q_{UHP}, Q_{VHP} and Q_{WHP} are P-MOS transistors, and ground side drive transistors Q_{UL}, Q_{VL} and Q_{WL} are N-MOS transistors. Predriver P1 controls on and off of power supply side drive transistors Q_{UHP}, Q_{VHP} and Q_{WHP}, and ground side drive transistors Q_{UL}, Q_{VL} and Q_{WL} based on the control signal input through input terminal IN1 from the outside. P-MOS transistors Q_{dup}, Q_{dvp} and Q_{dwp} are first, second and third overcurrent detection transistors, respectively, and have their gates in common with those of first, second and third power supply side drive transistors Q_{UHP}, Q_{VHP} and Q_{WHP}, respectively, for receiving the same control voltage.

Analog switch ASW1, analog switch ASW2 and analog switch ASW3 are turned on and off in association with first power supply side transistor Q_{UHP}, second power supply side transistor Q_{VHP} and third power supply side transistor Q_{WHP}, respectively. A constant current source I₁₁ selectively supplies a constant current to first overcurrent detection transistor Q_{dup}, second overcurrent detection transistor Q_{dvp} or third overcurrent detection transistor Q_{dwp}, to generate a reference voltage. The reference voltage corresponds to the level lower than power supply voltage Vcc by the product of the current value of constant current source I₁₁ and the on-resistance of first, second or third overcurrent detection transistor Q_{dup}, Q_{dvp} or Q_{dwp}, and is input to the non-inverting input terminal of overcurrent detection comparator CMP1. To the inverting input terminal of overcurrent detection comparator CMP1, the voltage corresponding to the level lower than power supply voltage Vcc by the product of the current flowing through first, second or third power supply side drive transistor Q_{UHP}, Q_{VHP} or Q_{WHP} and its on-resistance is selectively input through analog switch ASW1, ASW2 or ASW3.

The operation of overcurrent detection of coil load drive circuit 5 will now be described. For example, in the case where first power supply side drive transistor Q_{UHP} is on, second and third power supply side drive transistors Q_{VHP} and Q_{WHP} are off, first and second ground side drive transistors Q_{UL} and Q_{VL} are off, and third ground side drive transistor Q_{WL} is on, a current flows in the direction of the arrow shown by a long dashed line in FIG. 5, that is, from first power supply side drive transistor Q_{UHP} through U-phase coil load U_{L}, W-phase coil load W_{L} and third ground side drive transistor Q_{WL}.

In this case, analog switch ASW1 is on, analog switches ASW2 and ASW3 are off, the voltage of the drain of first power supply side drive transistor Q_{UHP} is input to the inverting input terminal of overcurrent detection comparator CMP1, and the voltage of the drain of first overcurrent detection transistor Q_{dup} is input as a reference voltage to the non-inverting input terminal. When an overcurrent flows through first power supply side drive transistor Q_{UHP} and the voltage of its drain drops lower than the reference voltage, the output of overcurrent detection comparator CMP1 is inverted. The output of overcurrent detection comparator CMP1 is then transmitted to predriver P1 to control such that first power supply side drive transistor Q_{UHP} is turned off. Thus, the overcurrent is prevented from continuously flowing. The above-described operation is performed in a similar manner also in the case where other power supply side drive transistors Q_{VHP} and Q_{WHP} are turned on and an overcurrent flows therethrough.

In this way, as with the above-described coil load drive circuit connected in the shape of an H-bridge, coil load drive circuit 5 which drives the 3-phase coil load can also eliminate the need for an external resistance as an overcurrent detection resistance to thereby achieve cost reduction, and to allow accurate overcurrent detection to be performed, since the value by which it is determined to be an overcurrent is constant irrespective of the temperature.

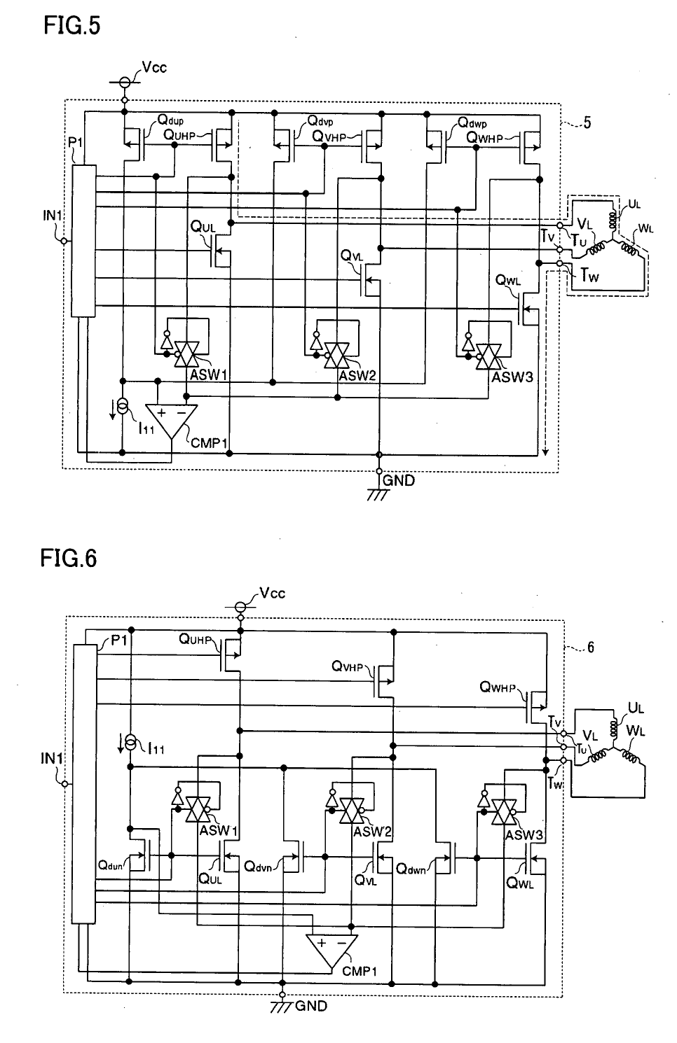

FIG. 6 shows a sixth embodiment of the present invention. The coil load drive circuit 6 is configured such that first, second and third overcurrent detection transistors Q_{dun}, Q_{dvn} and Q_{dwn}, which are N-MOS transistors, are arranged in parallel with first, second and third ground side drive transistors Q_{UL}, Q_{VL} and Q_{WL}. Constant current source I₁₁ selectively supplies a current from the power supply side to first, second or third overcurrent detection transistor Q_{dun}, Q_{dvn} or Q_{dwn}, and the reference voltage generated in transistor Q_{dun}, Q_{dvn} or Q_{dwn} is input to the non-inverting input terminal of overcurrent detection comparator CMP1. The voltage of the drain of first, second or third ground side drive transistor Q_{UL}, Q_{VL} or Q_{WL} (voltage of first, second or third output terminal) is selectively input to the inverting input terminal of overcurrent detection comparator CMP1.

Here, if a current increases at first, second or third ground side drive transistor Q_{UL}, Q_{VL} or Q_{WL}, the voltage caused by its on-resistance will increase. In overcurrent detection comparator CMP1, the voltage of the inverting input terminal becomes greater than the reference voltage input to the non-inverting input terminal when an overcurrent flows, and therefore, it inverts the output and provides the inverted output to predriver P1.

Although coil load drive circuits 5 and 6 are modified from coil load drive circuits 2 and 3, respectively, they can also be modified from coil load drive circuit 1. Furthermore, although coil load drive circuits 5 and 6 each have first, second and third power supply side drive transistors which are P-MOS transistors, it is also possible to replace these P-MOS transistors with N-MOS transistors occupying a smaller area in terms of the same current drive capability, to thereby allow the circuit scale to be reduced. Furthermore, as in coil load drive circuit 4 described above, a timing control circuit may be provided in coil load drive circuits 5 and 6, to prevent momentary malfunction of predriver P1.

A semiconductor device provided with the above-described coil load drive circuit is mounted on a printed board of electronic equipment such as an optical disk device. This semiconductor device needs no external resistance, to thereby allow the printed board to be reduced in size. It is to be noted that a drive transistor may be a separate semiconductor device. Of course, this semiconductor device can be provided with not only a coil load drive circuit but also circuits having other functions.

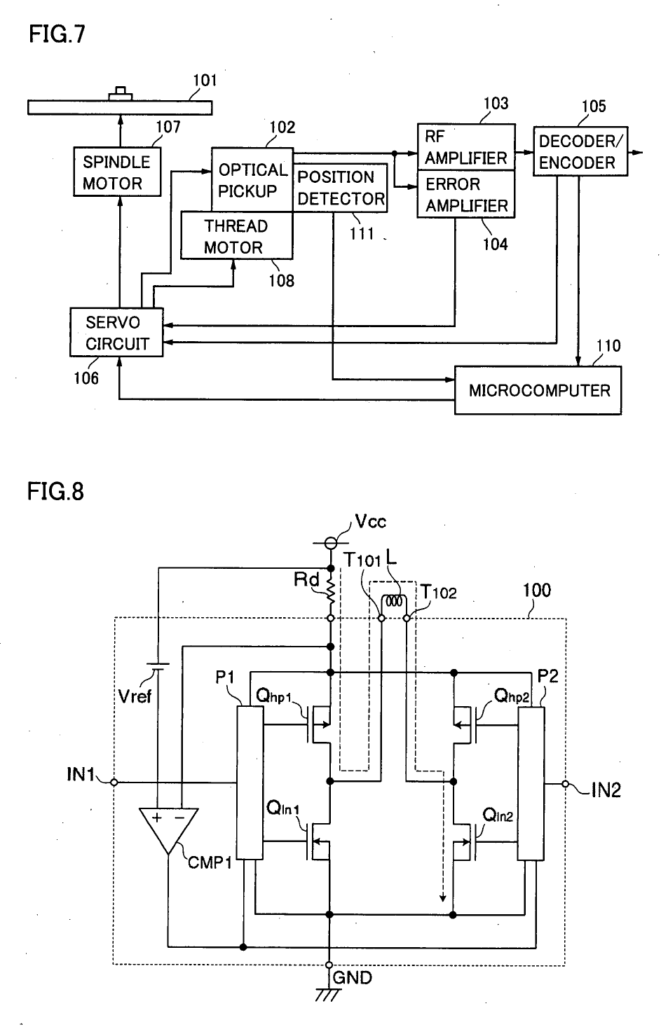

An optical disk device incorporating the above-described coil load drive circuit will now be described with reference to FIG. 7. This optical disk device includes an optical pickup 102, an RF amplifier 103, an error amplifier 104, an encoder/decoder 105, a servo circuit 106, a spindle motor 107, a thread motor 108, a microcomputer 110, and a position detector 111. The above-described coil load drive circuit is included in servo circuit 106.

Spindle motor 107 rotates optical disk 101, optical pickup 102 reads a signal from optical disk 101, and this signal is transmitted to RF amplifier 103 and error amplifier 104. An output signal of RF amplifier 103 is transmitted to encoder/decoder 105, and an output signal of error amplifier 104 is transmitted to servo circuit 106. Microcomputer 110 receives a signal from position detector 111, and controls servo circuit 106. For example, when optical disk 101 is prevented from rotating, the rotation number detected by position detector 111 is decreased. Therefore, microcomputer 110 transmits a signal to servo circuit 106 to increase the rotation number in order to keep the rotation number constant. The coil load drive circuit included in servo circuit 106 accordingly drives to increase the current flowing through the coil load of spindle motor 107. On the other hand, when an overcurrent flows, the coil load drive circuit performs control such that it may not continue to flow, as described in the above embodiments. Furthermore, also in the case where the motion of optical pickup 102 is prevented, the coil load drive circuit performs control such that an overcurrent may not continue to flow when it flows.

The optical disk device provided with the above-described coil load drive circuit needs no external resistance, thereby allowing reduction in size of the printed board, and accordingly, downsizing and cost reduction can be achieved.

While the coil load drive circuit and the optical disk device according to the embodiments of the present invention have been described above, the design of the present invention can be variously changed within the scope of the matters described in the claims, without being limited to the description in the embodiments. For example, overcurrent detection comparators CMP1 and CMP2 may each use an inverting circuit and the like at its preceding stage, to allow the polarities of the inverting input terminal and the non-inverting input terminal to be reversed. As for the analog switch, for example, the way of connecting the control terminals of analog switches ASW1 and ASW2 shown in FIG. 2 is not limited to the way as shown in the figure. They may be connected to the gates of ground side drive transistors Qₗₙ₁ and Qₗₙ₂, or may be connected independently to predrivers P1 and P2.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

1. A coil load drive circuit driving an end of a coil load through an output terminal at the midpoint between a power supply side drive transistor and a ground side drive transistor provided in series between a power supply voltage and a ground potential, and turning off any of the drive transistors when an overcurrent flows therethrough, comprising:
an overcurrent detection transistor receiving a control voltage of said power supply side drive transistor or a control voltage of said ground side drive transistor;
a constant current source supplying a constant current to the overcurrent detection transistor to generate a reference voltage; and
an overcurrent detection comparator comparing a voltage of said output terminal with said reference voltage to detect an overcurrent.

2. A coil load drive circuit driving both ends of a coil load through a first output terminal at the midpoint between a first power supply side drive transistor and a first ground side drive transistor provided in series between a power supply voltage and a ground potential, and a second output terminal at the midpoint between a second power supply side drive transistor and a second ground side drive transistor provided in series between said power supply voltage and said ground potential, and turning off any of the drive transistors when an overcurrent flows therethrough, comprising:
a first overcurrent detection transistor receiving a control voltage of said first power supply side drive transistor or a control voltage of said first ground side drive transistor;
a second overcurrent detection transistor receiving a control voltage of said second power supply side drive transistor or a control voltage of said second ground side drive transistor;
a constant current source selectively supplying a constant current to said first or second overcurrent detection transistor to generate a reference voltage; and
an overcurrent detection comparator selectively comparing a voltage of said first or second output terminal with said reference voltage to detect an overcurrent.

3. A coil load drive circuit driving a 3-phase coil load through a first output terminal at the midpoint between a first power supply side drive transistor and a first ground side drive transistor provided in series between a power supply voltage and a ground potential, a second output terminal at the midpoint between a second power supply side drive transistor and a second ground side drive transistor provided in series between the power supply voltage and the ground potential, and a third output terminal at the midpoint between a third power supply side drive transistor and a third ground side drive transistor provided in series between the power supply voltage and the ground potential, and turning off any of the drive transistors when an overcurrent flows therethrough, comprising:
a first overcurrent detection transistor receiving a control voltage of said first power supply side drive transistor or a control voltage of said first ground side drive transistor;
a second overcurrent detection transistor receiving a control voltage of said second power supply side drive transistor or a control voltage of said second ground side drive transistor;
a third overcurrent detection transistor receiving a control voltage of said third power supply side drive transistor or a control voltage of said third ground side drive transistor;
a constant current source selectively supplying a constant current to said first, second or third overcurrent detection transistor to generate a reference voltage; and
an overcurrent detection comparator selectively comparing a voltage of said first, second or third output terminal with said reference voltage to detect an overcurrent.

4. The coil load drive circuit according to any of claims 1-3, comprising means for controlling input timing of the voltage compared by said overcurrent detection comparator.

5. The coil load drive circuit according to claim 4, wherein said means for controlling the input timing of the voltage compared by said overcurrent detection comparator is a timing control circuit which controls the timings of the control voltage of said power supply side drive transistor or the control voltage of said ground side drive transistor and the control voltage of said overcurrent detection transistor.

6. An optical disk device comprising a coil load drive circuit 4,
said coil load drive circuit driving an end of a coil load through an output terminal at the midpoint between a power supply side drive transistor and a ground side drive transistor provided in series between a power supply voltage and a ground potential, and turning off any of the drive transistors when an overcurrent flows therethrough, said coil load drive circuit including
an overcurrent detection transistor receiving a control voltage of said power supply side drive transistor or a control voltage of said ground side drive transistor,
a constant current source supplying a constant current to the overcurrent detection transistor to generate a reference voltage, and
an overcurrent detection comparator comparing a voltage of said output terminal with said reference voltage to detect an overcurrent.

7. An optical disk device comprising a coil load drive circuit,
said coil load drive circuit driving both ends of a coil load through a first output terminal at the midpoint between a first power supply side drive transistor and a first ground side drive transistor provided in series between a power supply voltage and a ground potential, and a second output terminal at the midpoint between a second power supply side drive transistor and a second ground side drive transistor provided in series between said power supply voltage and said ground potential, and turning off any of the drive transistors when an overcurrent flows therethrough, said coil load drive circuit including
a first overcurrent detection transistor receiving a control voltage of said first power supply side drive transistor or a control voltage of said first ground side drive transistor,
a second overcurrent detection transistor receiving a control voltage of said second power supply side drive transistor or a control voltage of said second ground side drive transistor,
a constant current source selectively supplying a constant current to said first or second overcurrent detection transistor to generate a reference voltage, and
an overcurrent detection comparator selectively comparing a voltage of said first or second output terminal with said reference voltage to detect an overcurrent.

8. An optical disk device comprising a coil load drive circuit,
said coil load drive circuit driving a 3-phase coil load through a first output terminal at the midpoint between a first power supply side drive transistor and a first ground side drive transistor provided in series between a power supply voltage and a ground potential, a second output terminal at the midpoint between a second power supply side drive transistor and a second ground side drive transistor provided in series between the power supply voltage and the ground potential, and a third output terminal at the midpoint between a third power supply side drive transistor and a third ground side drive transistor provided in series between the power supply voltage and the ground potential, and turning off any of the drive transistors when an overcurrent flows therethrough, said coil load drive circuit including
a first overcurrent detection transistor receiving a control voltage of said first power supply side drive transistor or a control voltage of said first ground side drive transistor,
a second overcurrent detection transistor receiving a control voltage of said second power supply side drive transistor or a control voltage of said second ground side drive transistor,
a third overcurrent detection transistor receiving a control voltage of said third power supply side drive transistor or a control voltage of said third ground side drive transistor,
a constant current source selectively supplying a constant current to said first, second or third overcurrent detection transistor to generate a reference voltage, and
an overcurrent detection comparator selectively comparing a voltage of said first, second or third output terminal with said reference voltage to detect an overcurrent.
